(19) United States
(12) Patent Application Publication
(10) Pub. No.: US 2003/0101077 A1
(43) Pub. Date: May 29, 2003

(54) System for storing patient data

(76) Inventor: Daniel Wohl, Ruhstorf (DE)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 10/281,440

(22) Filed: Oct. 25, 2002

(30) Foreign Application Priority Data
Oct. 26, 2001 (DE) 10152300.9
Dec. 21, 2001 (DE) 20120795.8

(51) Int. Cl. G06F 17/60

(52) U.S. Cl. 705/2

(57) ABSTRACT

A system for storing patient data including a mobile re-writable storage medium that stores first patient data. The system also includes an input device for inputting the first patient data, and an output device, preferably mobile, for reading out the first patient data.

The present invention relates to a system for storing patient data.

Patient data i.a. is a patient's personal data such as, e.g., name and place of residence, emergency data such as, e.g., blood type, chronic and acute disorders, allergies. Patient data does, however, also include any other data of interest for medical treatment.

The exchange of data relating to a patient among medical practitioners is, however, presently still largely carried out in the form of paper documents.

This constitutes a drawback in particular when urgent need for action exists, such as in emergencies, however not all of a patient' relevant data is present at the treating physician's. Inadequate exchange of patient data between a family doctor and other physicians may moreover have the result that a treatment other than the optimum treatment is performed.

One solution for those problems is afforded by the basic model of a mobile medical record as presented by the inventor of the present invention at the IENA 2000, Nuremberg (DE).

In this basic model, a write/read unit connected to a computer is provided at the family doctor's. The patient has a data carrier incorporated into a digital watch, wherein the patient data are stored. This data carrier is protected by a safety code, with write authorization for the data carrier being assigned only to the family doctor's computer due to the fact that the safety code is stored therein.

In a case of emergency, the emergency physician may call up the patient data with the aid of a convenient scanner carried by him, by holding the data carrier near the scanner. The emergency physician has no write authorization.

As the digital clock a Swatch Access forming part of the SkiData® KeyWatch system may be used, for example.

This model of a mobile medical record has the drawback that the patient cannot call up the stored data outside the doctor's treatment facility. Availability of the patient data on any reading device moreover is a disadvantage in terms of data security. In an emergency it is furthermore awkward if the required data is concealed among a large number of called-up data.

The present invention has the object of avoiding the above mentioned drawbacks and to furnish a system for storing patient data that is easy to handle and safe in use.

The above mentioned object is achieved by a data storage system in accordance with claim 1. Hereby constant availability of up-to-date data at a patient's location is made possible through use of a re-writable storage medium with patient data which may be input via input means and output via output means.

When mobile output means are used, the storage medium may be read by an emergency physician, so that instantaneous and appropriate action at the location of an accident is facilitated.

Due to the fact that each set of data constitutes physiological or pathological information, it is possible to save examinations at a hospital which merely have the purpose of determining data that were already previously determined by another physician.

Through encoding patient data in the form of disorders as symbols, it is possible to use a storage medium having low storage capacity. For decryption of the symbols and displaying the full-text names of disorders, the output means include a corresponding software.

Through categorization of the patient data into various groups, wherein first patient data may be output via the mobile output means, but second patient data may not be output via the output means, the provision of unnecessary information at the location of an accident and a corresponding loss of time are prevented.

Through contactless writing on the storage medium and countactless reading from the storage medium it is possible to achieve further time saving.

Through use of a chip card as a storage medium, simple safekeeping, e.g., in a patient's wallet, may be ensured. Here it is possible to also store other data besides the patient data on the chip card, so that the number of chip cards carried by a patient is reduced.

If the storage medium is a microchip in a watch, availability of the patient data is improved.

In order to prevent unauthorized access to the patient data, the system may include safety means admitting reading/writing of data by authorized persons only. To be more precise, the input means may include encoder means, and the output means may include decoder means.

The safety means may be provided in the form of a safety code to be input into the apparatus prior to read-in and/or read-out.

Through electronic or optical storing of the patient data on the storage medium, the necessary storage space may be minimized.

A combination of input means and output means in one apparatus reduces the expense in terms of apparatus technology.

The advantages of the present invention will become more apparent when referring to the annexed drawings wherein:

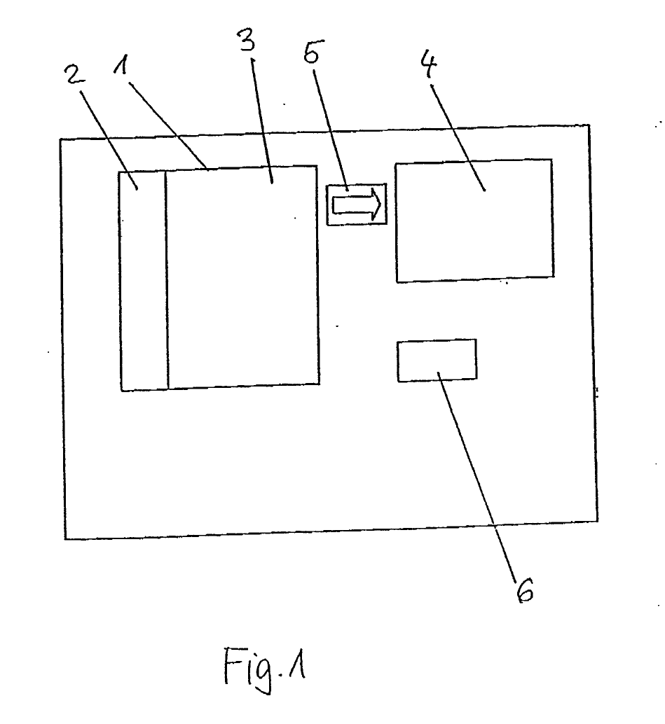

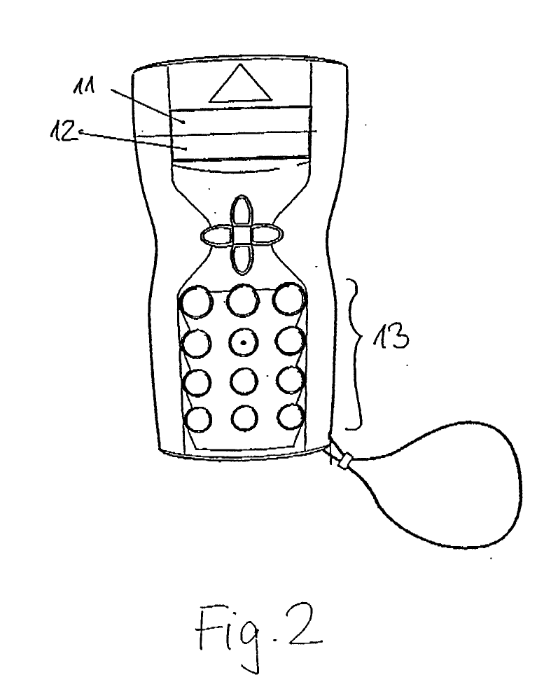

FIG. 1 represents a schematic drawing of the display of patient data on a computer monitor, and

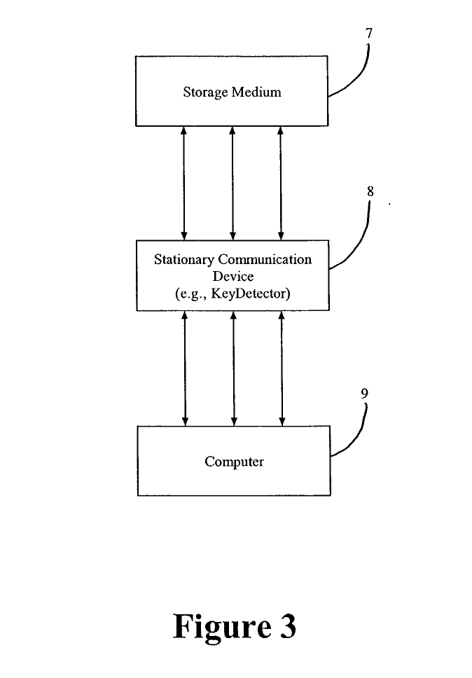

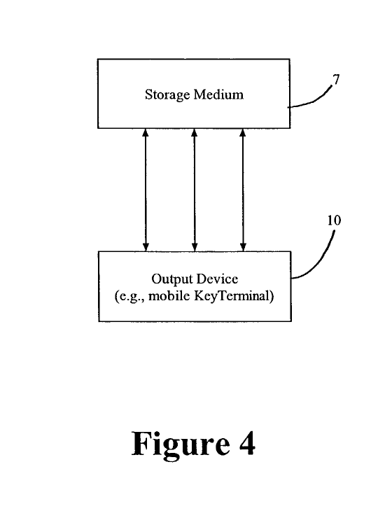

FIG. 2 is a schematic drawing of a SkiData® KeyTerminal employed in the present invention.

In the following, the present invention shall be explained by referring to the preferred embodiments.

A system for storing patient data in accordance with the present invention includes a mobile re-writable storage medium for storing patient data, input means for inputting patient data and output means for read-out of the patient data, and may be developed in accordance with the embodiments hereinbelow.

First Embodiment

In the first embodiment, a conventional Swatch Access on which patient data is storable in the form of symbols serves as a storage medium for the above-mentioned patient data. A SkiData® KeyDetector connected to a commercial computer in a conventional manner may be employed as an input device and as an output device for the patient data at the family physician's facilities. The computer has on it a software with a user surface which is exemplarily represented in FIG. 1.

In field 1 of FIG. 1, the patient data stored on the computer is displayed, while in field 4 the patient data stored on the Swatch Access is displayed in a case where the Swatch Access is located in proximity of the KeyDetector. Field 1 is subdivided into a first zone 2 in which symbols for patient data are displayed, and a second zone 3 in which the plain-text patient data is displayed. The symbols for the patient data may be arbitrary code for the patient data in the form of numerals and/or letters. By actuating a key 5, highlighted patient data may be transferred from the computer to the Swatch Access. Such transfer is, however, only possible if the computer is write authorized with regard to this Swatch Access. Write authorization may exist if a safety code was communicated to the physician by the patient and input by the physician into his computer. The safety code may be displayed in field 6 of FIG. 1.

The software is not limited to the above mentioned embodiment but may include a user interface in any suitable manner.

The emergency physician at a hospital may equally have the user surface represented in FIG. 1 displayed on the computer screen, in which case the write authorization in the form of fields 5 and 6 does, however, not exist. Reading out the patient data also is effected in the same way as at the family physician's facilities, e.g., with the aid of a KeyDetector.

An emergency physician on mobile duty is equipped with a hand-held output device as is shown by way of example in the form of the SkiData® Key Terminal in FIG. 2. When the KeyTerminal is held near the patient's Swatch Access, the KeyTerminal reads the stored data from the Swatch Access and displays the result on the display in the form of the full-text patient data. The display may, for example, represent two data sets of patient data in two lines 11 and 12, or display information concerning storage space and charge condition of the battery in the upper line and a data set of patient data in the lower line. The hand-held output device may, however, have a display of any format on which a multiplicity of patient data may be displayed.

The hand-held output device may be suited for connection of a printer through which the patient data displayed on the KeyTerminal can be printed. Preferably the contents of several lines are printed.

By the above described system for storing patient data, an emergency physician rapidly obtains the patient data at the location of an accident even though the patient may not be responsive. The patient data is equally available to the emergency physician at a hospital. By assigning the write authorization to none but the family physician, it is made sure that one physician is communicated any data forwarded as a result of examinations.

In an alternative embodiment, the patient may input a safety code having the form of a code number on the numeric pad of the KeyDetector and thus trigger the write authorization for his Swatch Access. In this way the emergency physician at a hospital may create entries on the Swatch Access. In one variant, the mobile emergency physician is furthermore provided with the possibility of inputting the code number via the numeric pad 13 (cf. FIG. 2), and of writing patient data on the Swatch Access in a case where the symbols for the patent data consist of numerals. Here it would be advantageous if the Swatch Access can store data for treatment in a hospital which may be read out in a simple manner in the hospital.

Second Embodiment

In the second embodiment, two data areas are defined in the memory of the Swatch Access. In the first data area, only the data necessary for rapid medical care at the location of an accident is entered. The second data area contains further data necessary for medical treatment at a hospital. For example, data such as a patient's name and address is insignificant at the location of an accident and may hence be recorded in the second area. Information relating to particular chronic ailments and medical intolerances, on the other hand, is already required at the location of an accident and therefore written into the first area.

The family physician as well as the emergency physician at the hospital can read the first and second areas of the Swatch Access memory. The mobile emergency physician at a location of accident, however, is displayed the first data area only, thus enabling his rapid comprehension of the relevant data with little effort.

Third Embodiment

The third embodiment further develops the first and second embodiments in that the patient data may be read out by the patient in central locations. Hereby the patient is enabled to constantly provide himself with information about diagnostic results and therapies. One possibility herefor is to install output devices in particular health facilities or at health insurance offices, whereby the patient data may be called up by approaching the Swatch Access. For enhanced security, the embodiment where a safety code has to be input prior to visualization of the patient data is preferable. In this way, data abuse is prevented for the case that a Swatch Access is lost.

In one variant, the patient may also call up the patient data at a computer in his home; this may also take place via the KeyDetector. Providing the patient with write authorization is not preferred as hereby data manipulations irritating the skilled person are to be expected.

Fourth Embodiment

The fourth embodiment differs from the first, second and third embodiments in the storage medium used. Whereas constant availability and high mobility are stressed in the case of the Swatch Access and similar storage media to be worn on the wrist, such as the KeyBand equally by SkiData®, use of a chip card, e.g. the SkiData® Keycard, offers the option of having patient data visualized at cash dispensing machines after entering the chip card safety code. To this end it is advantageous if cash dispensing machines are supplementarily equipped with a receiver unit for the patient data. As an alternative, the cash card function and the patient data storage function may be integrated in one card.

Fifth Embodiment

In the case of athletes, it would furthermore be possible to store, in addition to the above mentioned patient data, doping and physiological test data on the systems in accordance with the first through fourth embodiments. In this case, however, a requirement of inputting a safety code for each read process would be preferred in order to prevent data abuse.

It is an advantage in the SkiData® KeyWatch system employing the KeyCard and/or the Swatch Access in accordance with the above embodiments that the storage medium does not require a battery, for the energy required for storing is transmitted contactless to the storage medium. In this way, maintenance expenditure for the storage medium is low.

Sixth Embodiment

The above named embodiments are not limited to amplitude modulation in information transfer as in the cases of the Swatch Access and of the KeyCard, but any type of transfer may be employed, such as phase shift keying in the Proximity Card of the Finnish company Buscom, or infrared transfer and the like.

1. System for storing first patient data, including a mobile re-writable storage medium for storing the first patient data;
input means for inputting the first patient data, and
first output means for reading out the first patient data.

2. System in accordance with claim 1, wherein said first output means are mobile.

3. System in accordance with claim 1 or 2, wherein each one of at least two sets of data of the first patient data constitutes information that facilitates medical care for a patient in emergency cases.

4. System in accordance with claim 3, wherein each set of data constitutes physiological or pathological information concerning the patient.

5. System in accordance with claim 4 where the latter is appended to claim 2, wherein each set of data represents a symbol for a disorder, which is displayable on said mobile output means in the form of the name of that disorder.

6. System in accordance with any one of the preceding claims, including stationary output means for outputting the first patient data and second patient data which may be stored on said storage medium and may be input via said input means, however may not be output via said mobile output means.

7. System in accordance with claim 6, wherein writing on said storage medium via said input means is contactless, and reading out with the aid of said output means is contactless.

8. System in accordance with claim 7, wherein said storage medium is a chip card.

9. System in accordance with claim 8, wherein data for other areas, such as access data for cash dispensing machines, closure systems etc. are furthermore stored on said chip card.

10. System in accordance with claim 7, wherein said storage medium is a microchip in a watch.

11. System in accordance with any one of the preceding claims, including safety means allowing only an authorized person to input and/or output data.

12. System in accordance with claim 11, wherein said safety means include encoder means associated with said input means, for encryption of the data input via said input means, and/or decoder means associated with said output means for decoding the data stored on said storage medium.

13. System in accordance with claim 11 or 12, wherein said safety means has a safety code stored on said storage medium, allowing only an authorized person to input and/or output data.

14. System in accordance with any one of the preceding claims, wherein the patient data is stored electronically or optically on said storage medium.

15. System in accordance with any one of the preceding claims, wherein said input means and said output means are combined in one apparatus.
